(19) United States
(12) Patent Application Publication
(10) Pub. No.: US 2026/0186438 A1
(43) Pub. Date: Jul. 2, 2026

(54) IMAGE FORMING SYSTEM

(71) Applicant: FUJIFILM Business Innovation Corp., Tokyo (JP)

(72) Inventor: Masayoshi MIKI, Kanagawa (JP)

(73) Assignee: FUJIFILM Business Innovation Corp., Tokyo (JP)

(21) Appl. No.: 19/195,029

(22) Filed: Apr. 30, 2025

(30) Foreign Application Priority Data
Dec. 26, 2024 (JP) 2024-229983

(51) Int. Cl. G03G 15/00; G06F 3/12; H04N 1/00

(52) U.S. Cl. CPC G03G 15/5004; G06F 3/1221; G06F 3/1229; H04N 1/00037; H04N 1/00082

(57) ABSTRACT

An image forming system includes a processor configured to: when a human sensor has detected a person within a first area falling within a first distance from the human sensor, control the human sensor such that human detection is performed within a second area falling within a second distance from the human sensor shorter than the first distance and restore an image forming apparatus from a first power state to a second power state that is higher in power state than the first power state; and when the human sensor has detected a person in the second area, restore the image forming apparatus to a third power state that is higher in power state than the second power state.

### CROSS-REFERENCE TO RELATED APPLICATIONS

This application is based on and claims priority under 35 USC 119 from Japanese Patent Application No. 2024-229983 filed Dec. 26, 2024.

### BACKGROUND

### (i) Technical Field

The present disclosure relates to an image forming system.

### (ii) Related Art

Japanese Unexamined Patent Application Publication No. 2019-50627 discloses an image forming apparatus that includes a human sensor that is capable of detecting a person present within a detection area within a predetermined region and a controller that clears a power save mode in response to detection of the human sensor during the power save mode and causes an image former to perform a job.

In related-art mechanisms, a power save mode is cleared on an apparatus when a person enters an area surrounding the apparatus. In such a related-art mechanism, the apparatus responds to a person who just passes by the apparatus and the power save mode is unnecessarily cleared and power save properties may be degraded. On the other hand, if a detection zone is narrowed, the apparatus is delayed in a startup operation thereof, a user of the apparatus is kept waiting, and convenience for user decreases.

### SUMMARY

Aspects of non-limiting embodiments of the present disclosure relate to increasing power save properties while ensuring convenience for user of an apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including a processor configured to: when a human sensor has detected a person within a first area falling within a first distance from the human sensor, control the human sensor such that human detection is performed within a second area falling within a second distance from the human sensor shorter than the first distance and restore an image forming apparatus from a first power state to a second power state that is higher in power state than the first power state; and when the human sensor has detected a person in the second area, restore the image forming apparatus to a third power state that is higher in power state than the second power state.

### BRIEF DESCRIPTION OF THE DRAWINGS

Exemplary embodiment of the present disclosure will be described in detail based on the following figures, wherein:

FIG. 1 illustrates the configuration of an image forming system of an exemplary embodiment;

FIG. 2 illustrates the configuration of an image forming apparatus of the exemplary embodiment;

FIG. 3 illustrates a detection area of a human sensor;

FIG. 4 illustrates a power state of the image forming apparatus;

FIG. 5 is a flowchart illustrating a restoration process of the image forming apparatus;

FIGS. 6A and 6B illustrate detection distance tables of the human sensor;

FIGS. 7A and 7B illustrate variations in the detection area;

FIG. 8 illustrates the movement lines of persons;

FIG. 9 is a flowchart illustrating a first alternative control example of the restoration process of the image forming apparatus;

FIGS. 10A and 10B illustrate variations in the detection areas in the first alternative control example;

FIG. 11 is a flowchart illustrating a second alternative control example of the restoration process of the image forming apparatus;

FIGS. 12A and 12B illustrate variations in the detection area in the second alternative control example; and

FIG. 13 illustrates the configuration of a detection area including a first area and a direct restoration area.

### DETAILED DESCRIPTION

Exemplary embodiment of the disclosure is described below with reference to the drawings.

### Configuration of Image Forming System

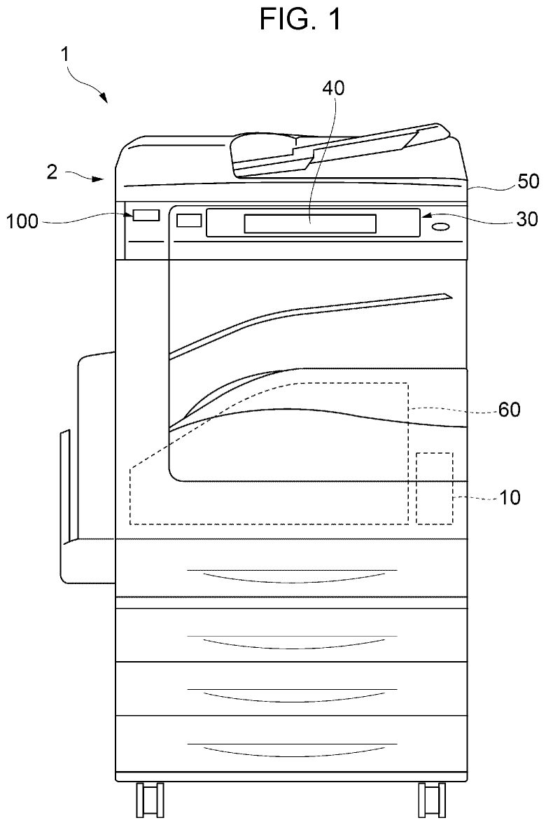

FIG. 1 illustrates the configuration of an image forming system 1 of the exemplary embodiment.

The image forming system 1 includes an image forming apparatus 2 that has a variety of functions including printing, scanning and copying. The image forming apparatus 2 is assumed to be installed in a place where people come and go, such as in offices or shared space.

### Configuration of Image Forming Apparatus

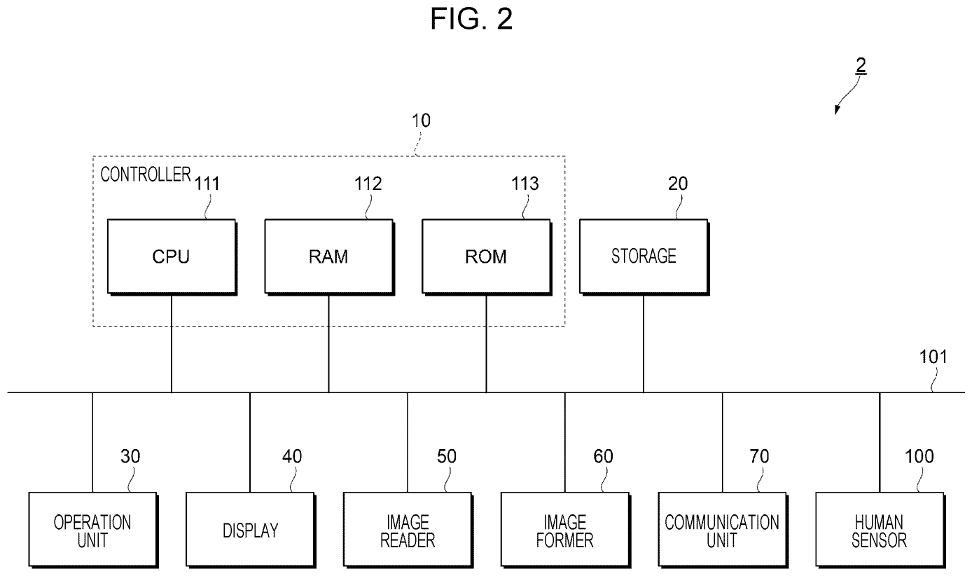

FIG. 2 illustrates the configuration of the image forming apparatus 2 of the exemplary embodiment. The image forming apparatus 2 includes a controller 10, storage 20 and operation unit 30. The image forming apparatus 2 further includes a display 40, image reader 50 and image former 60. The image forming apparatus 2 further includes a communication unit 70 and human sensor 100. These functional units are interconnected to a bus 101 and exchange data via the bus 101.

The controller 10 controls the functional units in the image forming apparatus 2. The controller 10 includes a central processing unit (CPU) 111 serving as an arithmetic unit, and a random-access memory (RAM) 112 and read-only memory (ROM) 113, serving as memory units. The RAM 112 is used as a working memory used by the CPU 111 when the CPU 111 performs an arithmetic operation. The ROM 113 stores programs and data, such as set values prepared in advance and the CPU 111 performs operations thereof by retrieving the programs and data directly from the ROM 113. The programs and data are also stored on the storage 20. The CPU 111 retrieves the programs stored on the storage 20 onto the RAM 112 and then executes the programs.

According to the exemplar embodiment, the CPU 111 in the controller 10 retrieves and executes the programs, thus implementing a variety of functions. The functions implemented in the exemplary embodiment includes controlling the operation of each functional unit, controlling a power state of the image forming apparatus 2 and controlling a detection distance of the human sensor 100. These functions are described below in detail.

The storage 20 is a functional unit that stores not only programs to be executed by the CPU 111 and data but also a variety of data generated in a variety of operations, such as image data read by the image reader 50. The storage 20 is implemented by a magnetic disk, a solid state drive (SSD), or the like.

The operation unit 30 is a functional unit that receives operations of a user. The operation unit 30 includes, for example, a hardware key and a touch sensor that outputs a control signal responsive to a position pressed or touched by a finger or the like. The operation unit 30 may be a touch panel that is a combination of a touch sensor and a liquid-crystal display forming the display 40.

The display 40 is a functional unit that displays an information screen presenting a variety of information of the user, a preview screen of an image serving as an operation target to be read or output, an operation image operated by the user, and the like. The display 40 is configurated to include a liquid-crystal display. A combination of the operation unit 30 and display 40 serves a user interface that the user uses to input and output information to and from the image forming apparatus 2.

The image reader 50 is a functional unit that optically reads an image on an original document. The methods of image reading include, for example, a charge-coupled device (CCD) method that converges and receives reflected light responsive to light that a light source radiates onto an original document and a contact image sensor (CIS) method that receives reflected light responsive to light that a light-emitting diode (LED) light source successively radiates onto an original document.

The image former 60 is a functional unit that forms on a medium, such as a paper sheet, an image responsive to image data by using an image forming material. The method of forming an image on a medium includes, for example, an electrophotographic system that forms an image by using toner as the image forming material and by transferring the toner stuck to a photoconductor to the medium.

The communication unit 70 is a functional unit that exchanges instructions and data with an external apparatus. The communication unit 70 may be an interface that supports a communication method with an external apparatus. The communication unit 70 may be connected with the external apparatus via a network or may be directly connected with the external apparatus. The communication network may be a wired network or a wireless network.

The human sensor 100 detects a person present around the image forming apparatus 2.

The human sensor 100 may be a detection sensor that includes an output unit outputting a signal and a detector detecting the signal. In such a case, the human sensor 100 obtains detection results that are different depending on whether the detector detects the signal output by the output unit.

The human sensor 100 may be any sensor as long as the sensor is able to detect a moving body, such as a person.

The human sensor 100 may be an ultrasonic wave sensor, a sensor using light, a sensor using radio waves or a sensor that recognizes the body temperature of a person. The method of the human sensor 100 may include recognizing a person by analyzing an image captured using a variety of photographing units. In another method, an example of these sensors recognizes the presence of a person when a detection unit detects a signal reflected from the person with the person irradiated with a signal transmitted from an output unit. When the reflected signal is not detected in that method, the presence of the person is not detected.

The ultrasonic wave sensor performs detection by receiving with a detection unit an ultrasonic wave reflected from a person when the person is irradiated with an ultrasonic wave transmitted from an output unit. The sensor using light performs detection by receiving with a detection unit light reflected from a person when the person is irradiated with light emitted from an output unit. The sensor using radio wave performs detection by receiving with a detection unit a radio wave reflected from a person when the person is irradiated with a radio wave radiated by an output unit.

The human sensor 100 of the exemplary embodiment has a function of adjusting output strength of an output unit. For example, the human sensor 100 may change a detection distance thereof by adjusting the output strength of the output unit. Specifically, as the output strength is increased, the signal travels farther and the detection distance increases. On the other hand, as the output strength is decreased, the coverage of the signal is narrowed and the detection distance decreases.

According to the exemplar embodiment, the detection distance of the human sensor 100 is switched from one set value to another set value by controlling the output strength. The set values are stored in a detection distance table described below.

### Detection Area of Human Sensor

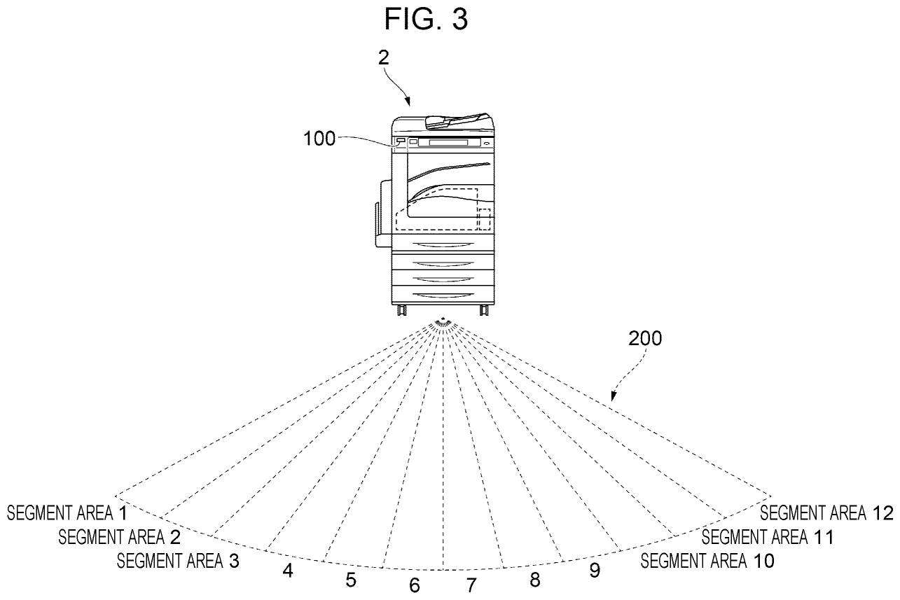

FIG. 3 illustrates a detection area 200 of the human sensor 100.

The human sensor 100 outputs a signal, such as an ultrasonic wave, in a specific direction at a predetermined output strength and searches for the presence of a person within a specific range. For example, the human sensor 100 successively outputs the signal in multiple directions by changing angle. In this way, the human sensor 100 searches for the presence of a person within the detection area 200 that expands in a sector centered on the image forming apparatus 2.

The human sensor 100 outputs a signal at an angle while changing the angle in steps of about 10 degrees within a range of 0 degrees to 120 degrees centered on the image forming apparatus 2. That angle setting is described for exemplary purposes only and other angle setting is also possible.

To control the output direction of the signal, a considered method is to change the output direction of the signal by causing a motor to rotate an output unit. To control the output direction of the signal, another considered method is to secure the output unit and cause the signal to be reflected on a mirror element with the angle adjustable with the motor.

The detection area 200 expanding in a sector centered on the image forming apparatus 2 is formed as illustrated in FIG. 3. The detection area 200 illustrated in FIG. 3 is described for exemplary purposes only and the detection area of the image forming apparatus 2 is not limited to the detection area 200. The detection area 200 may be set up in view of the environment where the image forming apparatus 2 is installed. The detection area may be expanded or shrunk by controlling the output direction of the signal.

The detection area 200 includes multiple areas respectively corresponding to the directions in which the human sensor 100 emits the signal and each area is referred to as a “segment area.”

FIG. 3 illustrates segment areas 1 through 12. The human sensor 100 successively outputs the signal to the segment areas 1 through 12 in that order to detect the presence of a person in each segment area. The order of outputting the signal is not limited to the order described above. For example, the human sensor 100 outputs the signal successively in the segment areas 12 through 1 in that order. The number of segment areas is described for exemplary purposes only and is not limited to 12.

Setting up an area that is to be excluded from the target detection area is also possible. For example, the human sensor 100 may unnecessarily respond when the image forming apparatus 2 is installed on the corner of a room or in a place where people come and go. In such a case, the detection area of the human sensor 100 may be set up in advance such that unnecessary detection is avoided.

For example, to exclude segment areas 7 through 12 illustrated in FIG. 3 from the detection target, the presence of a person may be detected within the segment areas 1 through 6 by adjusting the output direction of the signal. The human sensor 100 successively outputs the signal on each of the segment areas 1 through 6 and may detect the presence of a person within the detection area 200 by repeating that process.

The human sensor 100 of the exemplary embodiment may include mutually independent multiple output units. For example, the human sensor 100 may be configurated to arrange an output unit for each segment area to detect the presence of a person within each segment area. With respect to the segment areas 1 through 12 illustrated in FIG. 3 in this configuration, 12 output units are respectively arranged for the 12 segment areas to output the signal in different directions in search of a person each segment area. In this case, the segment areas may be concurrently searched, leading to an increase in detection accuracy. Note that the human sensor 100 may be configurated to set the number of output units to be smaller than the number of segment areas and to output the signal with the angles thereof changed.

### Power State of Image Forming Apparatus

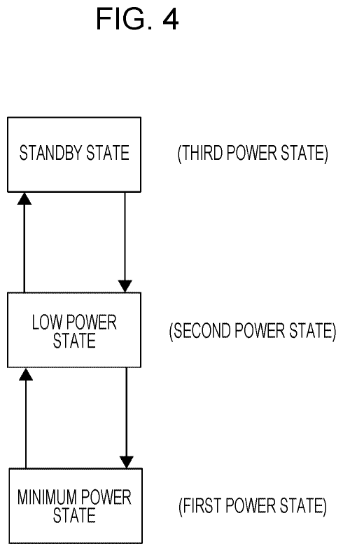

FIG. 4 illustrates the power state of the image forming apparatus 2.

The image forming apparatus 2 of the exemplary embodiment has multiple power modes that are different in terms of power consumption level. In other words, the image forming apparatus 2 may be set in multiple power states that are different in terms of power consumption.

The image forming apparatus 2 supports as a first power state, for example, a “minimum power state” that minimizes the power consumption. The minimum power state is one of the power states that is applicable when no job is performed to minimize the power consumption of the image forming apparatus 2. The minimum power state may also be referred to as a sleep state.

The power consumption of the image forming apparatus 2 is restricted to the minimum necessary amount in the minimum power state. In the minimum power state, only a minimum function, for example, part of the human sensor 100 and part of the controller 10 are operative. In an example of the minimum power state, the function of each the display 40, the image reader 50 and the image former 60 is caused to be inoperative except the operation of part of the operation unit 30 and the communication unit 70 used for restoration. The operational state of each of the functional units in the minimum power state may be set up in view of the necessary operational state of the image forming apparatus 2.

The image forming apparatus 2 also supports as a second power state a “low power state” that is higher in power consumption than the minimum power state. In the low power state, the image forming apparatus 2 is restored more quickly than in the minimum power state while restricting power consumption. The low power state consumes power lower than in the standby state described below and thus consumes power between the minimum power state and the standby state. The operational state of each functional unit in the low power state is set in view of the necessary operational state of the image forming apparatus 2.

The image forming apparatus 2 supports as a third power state the “standby state” in which a variety of jobs are executable. In the standby state, each functional unit is operative and each job is executable when an operation of the user is received. For example, a job, such as printing, scanning or copying is executable. Since an operation screen is displayed with the display 40 on, each functional unit, such as the image former 60 is powered and power consumption is thus increased.

According to the exemplar embodiment, the image forming apparatus 2 is restored from the minimum power state to the standby state after passing through the low power state. Note that the image forming apparatus 2 may be restored from the minimum power state to the standby state without passing through the low power state.

### Restoration Process of Image Forming Apparatus

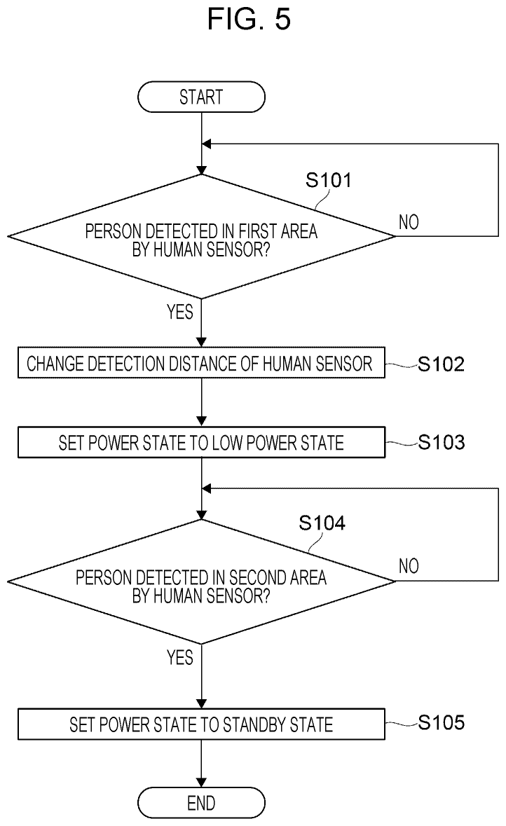

The control of a restoration process of the image forming apparatus 2 is described with reference to FIGS. 5 through 7. The control is implemented when the CPU 111 in the controller 10 retrieves and executes a program.

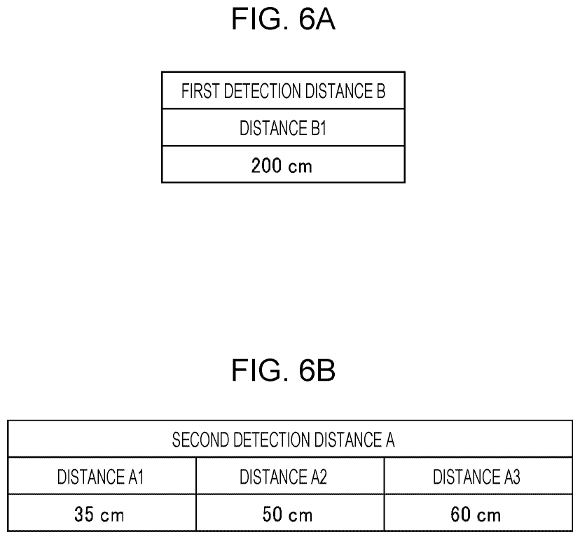

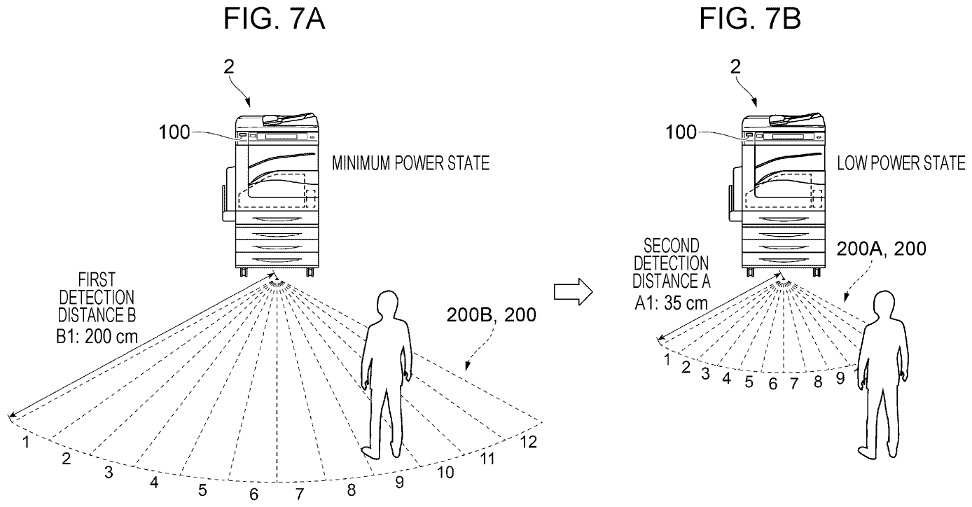

FIG. 5 is a flowchart illustrating the restoration process of the image forming apparatus 2. FIGS. 6A and 6B illustrate detection distance tables of the human sensor 100. FIG. 6A illustrates the table listing first detection distances B. FIG. 6B illustrates the table listing second detection distances A. FIGS. 7A and 7B are diagrams illustrating variations in the detection area 200. FIG. 7A illustrates the detection area 200 before the detection distance is changed. FIG. 7B illustrates the detection area 200 after the detection distance is changed.

The detection area 200 before the detection distance is changed is hereinafter referred to as a “first area 200B.” The detection area 200 after the detection distance is changed is hereinafter referred to as a “second area 200A.”

With the image forming apparatus 2 waiting in the minimum power state, the controller 10 determines whether the human sensor 100 has detected a person in the first area 200B (step S101). If the human sensor 100 has not detected a person in the first area 200B (no in step S101), the controller 10 is waiting.

If the human sensor 100 has detected a person in the first area 200B (yes in step S101), the controller 10 changes the detection distance (step S102). The controller 10 performs control to shorten the detection distance of the human sensor 100.

The controller 10 sets the power state of the image forming apparatus 2 to the low power state (step S103). Note that the operations in steps S102 and S103 may be performed in reverse order or concurrently.

The controller 10 determines whether the human sensor 100 has detected a person in the second area 200A (step S104). If the human sensor 100 has not detected a person in the second area 200A (no in step S104), the controller 10 is waiting. If the human sensor 100 has detected a person in the second area 200A (yes in step S104), the controller 10 sets the power state of the image forming apparatus 2 to the standby state (step S105).

Through that series of operations, the image forming apparatus 2 is restored from the low power state to the standby state in a stepwise fashion.

According to the exemplar embodiment, the storage 20 stores multiple tables defining the detection distances. In the determination in step S101, the table listing first detection distance B illustrated in FIG. 6A is used.

The table illustrated in FIG. 6A lists “distance B1” as the first detection distance B. “Distance B1: 200 cm” is herein listed as an example of the first detection distance B. As illustrated in FIG. 7A in step S 101, with respect to the distance B1 as a standard, the human sensor 100 searches for the presence of a person in the first area 200B expanded in a sector centered on the image forming apparatus 2.

When the detection distance of the human sensor 100 is changed in step S102, the table listing the second detection distances A illustrated in FIG. 6B is used. The table illustrated in FIG. 6B lists “distance A1” as the second detection distance A. “Distance A1: 35 cm” is listed herein as an example of the second detection distance A. In step S102, the detection distance of the human sensor 100 is changed to the distance A1.

In step S104, with respect to the distance A1 as a standard as illustrated in FIG. 7B, the human sensor 100 searches for the presence of a person in the second area 200A expanded in a sector centered on the image forming apparatus 2.

The process of resetting the second area 200A is described below. When a predetermined time period has elapsed with no person detected in the second area 200A since the change of the detection area 200 to the second area 200A, the detection area 200 is restored back to the first area 200B. The controller 10 then shifts the image forming apparatus 2 to the minimum power state. The process of shifting to the minimum power state after passing through the low power state may also be employed. This process may be performed when no person is detected any more in the second area 200A after a person is detected in the first area 200B or when the person has left the second area 200A since the execution of a job.

In the table illustrated in FIG. 6A, “distance B1: 200 cm” is set as the first detection distance B but this set value is determined in view of energy saving of the image forming apparatus 2 and convenience for a person who uses the image forming apparatus 2 and the exemplary embodiment is not limited to this set value. For example, the first detection distance B may be set to be about 150 cm shorter than 200 cm. Since the detection range is shorter than when the first detection distance B is set to be 200 cm, starting caused by erroneous detection is reduced and power consumption is reduced. Also, the first detection distance B may be set to be about 250 cm longer than 200 cm. In such a case, the presence of a person is detected more quickly than when the first detection distance B is set to be 200 cm, and thus the power state may be efficiently changed. The first detection distance B is set up in view of the place where the image forming apparatus 2 is installed.

In the table illustrated in FIG. 6B, the second detection distance A is “distance A1: 35 cm” but this set value is an example only and the exemplary embodiment is not limited to this set value.

The image forming apparatus 2 is restored once back to the low power state in the restoration process when a person is detected in the first area 200B. Since the image forming apparatus 2 is free from restoring back to the standby state, energy saving may thus be promoted.

Convenience for a user of the image forming apparatus 2 may also be promoted by setting up the second area 200A smaller than the first area 200B and restoring the image forming apparatus 2 back to the standby state when a person is detected in the second area 200A.

### First Alternative Control Example

First alternative control example of the image forming apparatus 2 is described below with reference to FIGS. 6A, 6B, and 8 through 10B. The first alternative control example is different from the above-described control example in that the second detection distance A is set up in view of the movement line of each person in the first alternative control example when the detection distance of the human sensor 100 is changed. The first alternative control example is performed when the CPU 111 in the controller 10 retrieves and executes the program.

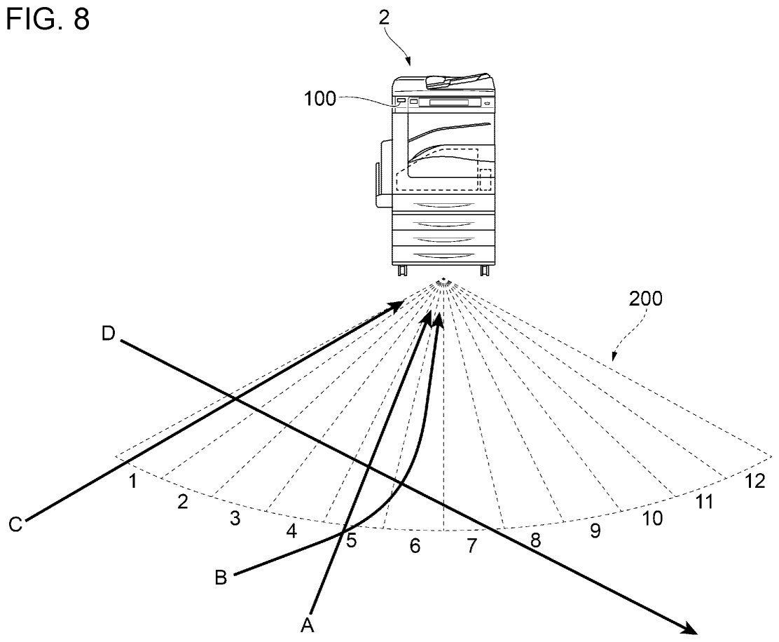

FIG. 8 illustrates movement lines of persons. When the image forming apparatus 2 is installed in a place where people come and go, some may move closer to use the image forming apparatus 2 but others may simply pass by the image forming apparatus 2. The movement lines of persons moving closer to the image forming apparatus 2 may be varied and for example, a person may approach the image forming apparatus 2 in a straight line or a curved line.

For example, line A in FIG. 8 represents the movement line of a person who intends to use the image forming apparatus 2 and approaches the image forming apparatus 2 in a straight line. Line B in FIG. 8 represents the movement line of a person who intends to use the image forming apparatus 2 and approaches the image forming apparatus 2 in a curved line. Line C in FIG. 8 represents the movement line of a person who intends to use the image forming apparatus 2 and approaches the image forming apparatus 2 from the side direction thereof. Line D in FIG. 8 represents the movement line of a person who simply passes by the image forming apparatus 2.

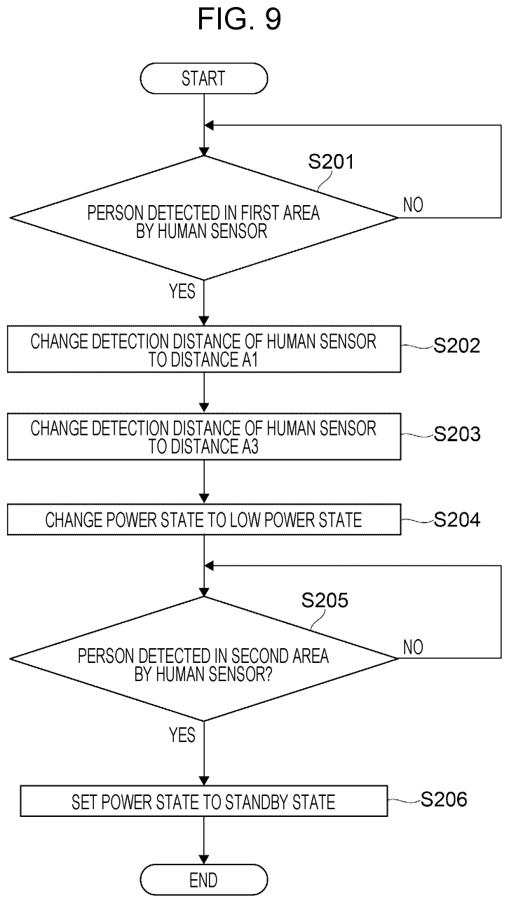

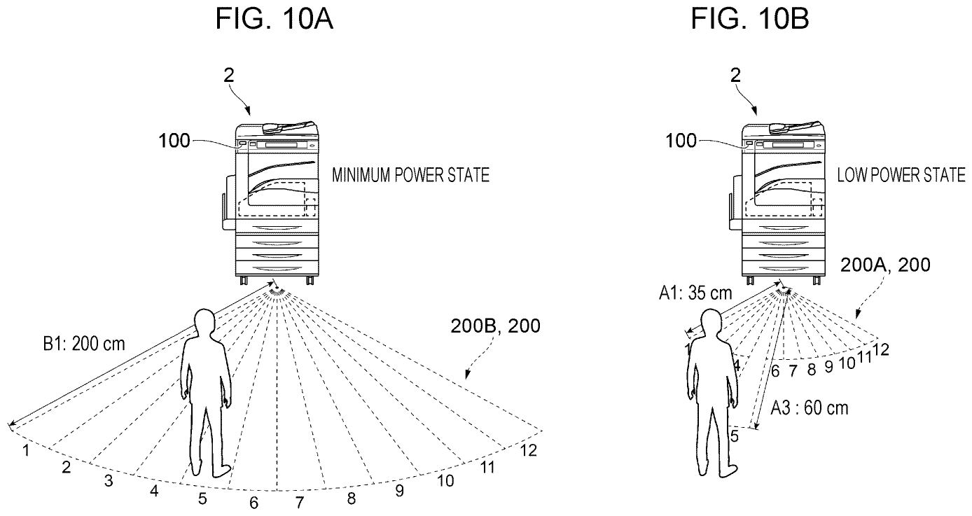

FIG. 9 is a flowchart illustrating the first alternative control example of the restoration process of the image forming apparatus 2. FIGS. 10A and 10B illustrate variations in the detection area 200 in the first alternative control example. FIG. 10A illustrates the detection area 200 before the detection distance is changed. FIG. 10B illustrates the detection area 200 after the detection distance is changed.

With the image forming apparatus 2 waiting in the low power state, the controller 10 determines whether the human sensor 100 has detected a person in the first area 200B (step S201). If the human sensor 100 has detected no person in the first area 200B (no in step S201), the controller 10 stays in wait.

If the human sensor 100 has detected a person in the first area 200B (yes in step S201), the controller 10 changes the detection distance of the human sensor 100 to distance A1 (step S202). The controller 10 changes the detection distance of the human sensor 100 to distance A3 in a specific direction connecting between the location where the person has been detected and the image forming apparatus 2 (step S203).

The controller 10 changes the power state of the image forming apparatus 2 to the low power state (step S204). Operations in steps S202 through S204 may be performed in any order or concurrently.

The controller 10 confirms whether the human sensor 100 has detected a person in the second area 200A (step S205). If the human sensor 100 has detected no person in the second area 200A (no in step S205), the controller 10 stays in wait. If the human sensor 100 has detected a person in the second area 200A (yes in step S205), the controller 10 changes the power state of the image forming apparatus 2 to the standby state (step S206).

In the first alternative control example, the table listing the first detection distance B illustrated in FIG. 6A is used in the determination in step S201. In step S201, the human sensor 100 searches for the presence of a person in the first area 200B based on distance B1 as illustrated in FIG. 10A.

The human sensor 100 searches each of the segment areas in the first area 200B for the presence of a person. The first area 200B is configurated to include the segment areas 1 through 12 as illustrated in FIG. 10A and the human sensor 100 successively searches the segment areas 1 through 12.

When the detection distance of the human sensor 100 is changed in step S202, the table listing the second detection distance A illustrated in FIG. 6B is used. In the first alternative control example, two distance data of distance A1 and distance A3 are used as the second detection distance A. The lengths of the detection distance are related as being distance A1<distance A3. In step S202, the detection distance of the human sensor 100 is changed to distance A1.

Furthermore in step S203 in the first alternative control example, the detection distance of the human sensor 100 is changed to distance A3 longer than distance A1 in the specific direction connecting between the location where the person has been detected and the image forming apparatus 2.

In step S205, the human sensor 100 searches for the presence of a person in the second area 200A after the detection distance of the human sensor 100 is changed.

In step S201, the human sensor 100 may have detected a person in the segment area 5 within the first area 200B.

In this case, in step S202, the detection distance of the human sensor 100 is changed to distance A1 and in step S203, the detection distance of the human sensor 100 is changed to distance A3 longer than distance A1 in the segment area 5 where the person has been detected.

In step S205, the human sensor 100 searches for the presence of a person in the second area 200A after the detection distance of the human sensor 100 is changed as illustrated in FIG. 10B.

In the first alternative control example, the second detection distance A is extended more in an area corresponding to the specific direction connecting between the location where the person has been detected and the image forming apparatus 2 than the other areas where no person has been detected. The timing of detecting a person in the second area 200A may be advanced on a person approaching the image forming apparatus 2 in a straight line as illustrated in FIG. 8. As a result, the image forming apparatus 2 may be efficiently restored and convenience for user may be increased.

### Second Alternative Control Example

A second alternative control example of the restoration process of the image forming apparatus 2 is described with reference to FIGS. 6A, 6B, 8, 11, and 12A and 12B. The second alternative control example is different from the first alternative control example in the operation of setting the second detection distance A. The second alternative control example is implemented when the CPU 111 in the controller 10 retrieves and executes the program.

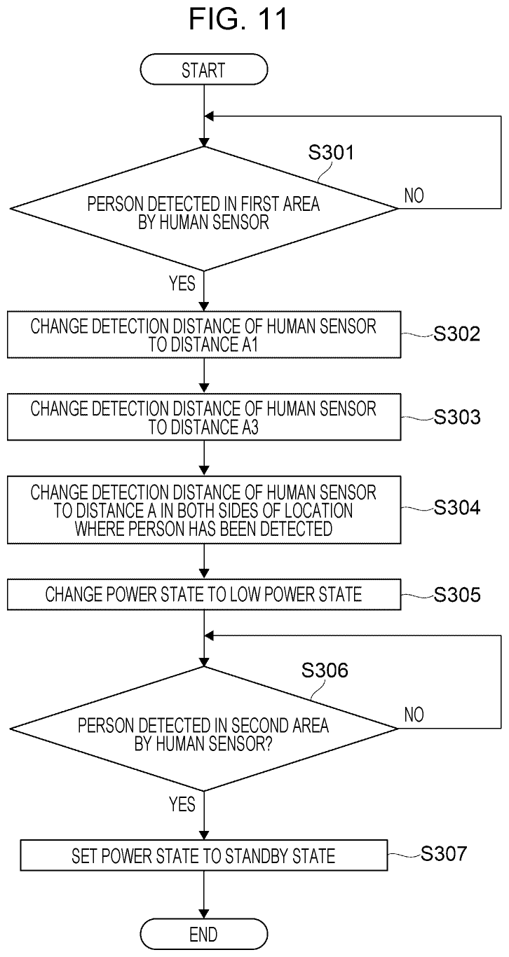

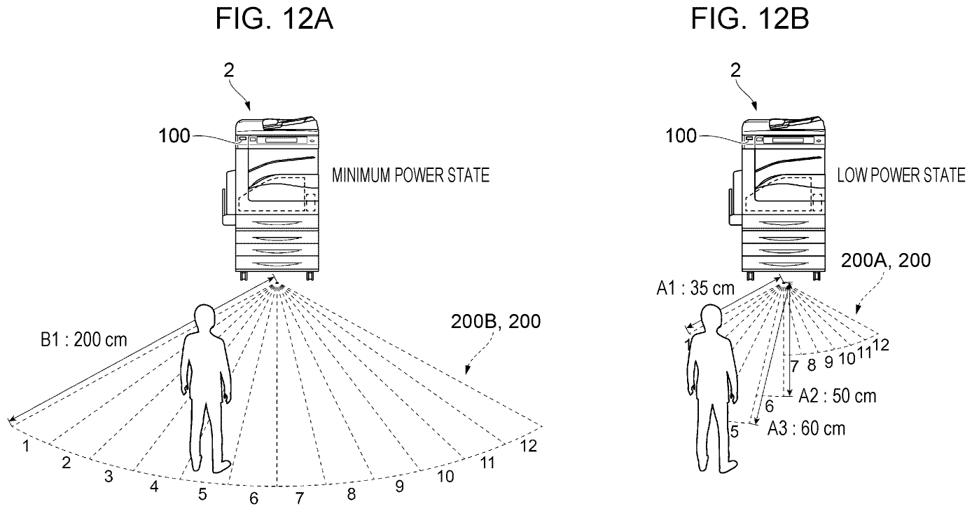

FIG. 11 is a flowchart illustrating the second alternative control example of the restoration process of the image forming apparatus 2. FIGS. 12A and 12B illustrate variations in the detection area 200 in the second alternative control example. FIG. 12A illustrates the detection area 200 before the detection distance is changed. FIG. 12B illustrates the detection area 200 after the detection distance is changed.

With the image forming apparatus 2 staying in wait in the low power state, the controller 10 determines whether the human sensor 100 has detected a person in the first area 200B (step S301). If the human sensor 100 has detected no person in the first area 200B (no in step S301), the controller 10 stays in wait.

If the human sensor 100 has detected a person in the first area 200B (yes in step S301), the controller 10 changes the detection distance of the human sensor 100 to distance A1 (step S302). The controller 10 changes the detection distance of the human sensor 100 to distance A3 in a specific direction connecting between the location where the person has been detected and the image forming apparatus 2 (step S303). The controller 10 further changes the detection distance of the human sensor 100 to distance A2 in both sides of the location where the person has been detected (step S304).

The controller 10 changes the power state of the image forming apparatus 2 to the low power state (step S305). Note that operations in steps S302 through S305 may be performed in any order or concurrently.

The controller 10 confirms whether the human sensor 100 has detected a person in the second area 200A (step S306). If the human sensor 100 has detected no person in the second area 200A (no in step S306), the controller 10 stays in wait. If the human sensor 100 has detected a person in the second area 200A (yes in step S306), the controller 10 changes the power state of the image forming apparatus 2 to the standby state (step S307).

In the second alternative control example as well, the table listing the first detection distance B illustrated in FIG. 6A is used in the determination in step S301. In step S301, the human sensor 100 searches for the presence of a person in the first area 200B based on distance B1 as illustrated in FIG. 12A. The human sensor 100 then successively searches each of the segment areas in the first area 200B.

When the detection distance of the human sensor 100 is changed in step S302, the table listing the second detection distance A illustrated in FIG. 6B is used. Three distance data “distance A1,” “distance A2” and “distance A3” are used as the second detection distance A in the second alternative control example. The lengths of the detection distances are related as being distance A1<distance A2<distance A3. The detection distance of the human sensor 100 is changed to distance A1 in step S302.

In step S303, the detection distance of the human sensor 100 is changed to distance A3 in an area corresponding to the location where the person has been detected.

In step S304 in the second alternative control example, the detection distance of the human sensor 100 is changed to distance A2 in an area adjacent to the location where the person has been detected.

In step S306, the human sensor 100 searches for the presence of a person in the second area 200A after the detection distance of the human sensor 100 is changed.

In step S301, the human sensor 100 may have detected a person in the segment area 5 in the first area 200B.

In step S302, the detection distance of the human sensor 100 is changed to A1 and in step S303, the detection distance of the human sensor 100 is changed to distance A3 longer than distance A1 in the segment area 5 where the person has been detected.

In step S304, the detection distance of the human sensor 100 is changed to distance A2 longer than distance A1 in segment areas 4 and 6 adjacent to the segment area 5 where the person has been detected.

The detection distance of the human sensor 100 is distance A1 in the segment areas 1 through 3 and 7 through 12 among the segment areas 1 through 12 as illustrated in FIG. 12B. The detection distance of the human sensor 100 is distance A2 in the segment areas 4 and 6. The detection distance of the human sensor 100 is distance A3 in the segment area 5 as the location where the person has been detected.

In step S306, the human sensor 100 searches for the presence of a person in the second area 200A after the detection distance is changed.

In the second alternative control example, the detection distance of the human sensor 100 is controlled such that the second detection distance A is extended not only to a segment area corresponding to an area connecting between the location where the person has been detected and the image forming apparatus 2 but also to a segment area adjacent to that segment area. In a predetermined area including a specific direction connecting between the location where the person has been detected and the image forming apparatus 2, the detection distance of the human sensor 100 is controlled such that detection distance for person becomes longer as a position is closer to the specific direction. In the second alternative control example, the timing of detecting a person in the second area 200A is advanced on a person approaching the image forming apparatus 2 in a curved line as illustrated in FIG. 8.

### Third Alternative Control Example

In the control examples described above, the power state of the image forming apparatus 2 is restored in a stepwise fashion. Quicker restoration of the image forming apparatus 2 may be sometimes requested along the movement line of a person who is going to use the image forming apparatus 2. Convenience for the person who uses the image forming apparatus 2 may be increased by restoring the image forming apparatus 2 from the low power state directly to the standby state.

The image forming apparatus 2 is directly restored from the minimum power state to the standby state when a person has been detected in a predetermined area. The predetermined area is hereinafter referred to as “direct restoration region 200C.”

In the following discussion, a person approaches the image forming apparatus 2 from a side direction of the image forming apparatus 2. A person approaching from the side direction of the image forming apparatus 2 is more likely to use the image forming apparatus 2 than a person passing through the front side of the image forming apparatus 2. Based on the determination that the person approaching from the side direction of the image forming apparatus 2 is going to use the image forming apparatus 2, the image forming apparatus 2 is restored from the minimum power state directly to the standby state.

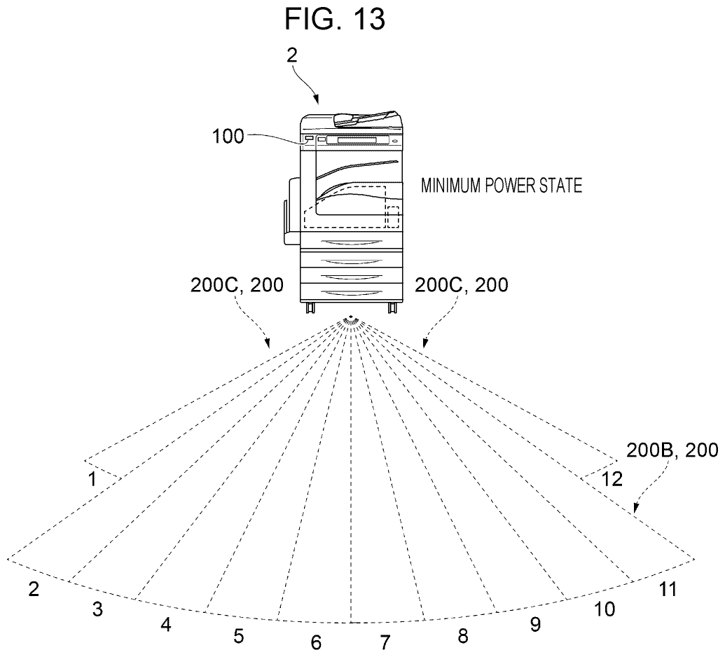

FIG. 13 illustrates the configuration of the detection area 200 including the first area 200B and direct restoration region 200C.

Segment areas 2 through 11 form, for example, the first area 200B as illustrated in FIG. 13. Segments 1 and 12 form the direct restoration region 200C.

When a person is detected in any of the segment areas 2 through 11 in a third alternative control example, the same process as one of the alternative control examples described above is performed to restore the image forming apparatus 2 in a stepwise fashion. On the other hand, when the human sensor 100 has detected the presence of a person in the segment area 1 or 12, the image forming apparatus 2 is restored from the minimum power state directly to the standby state. Efficient restoration process may thus be performed in view of the movement line of a person who is presumed to have the intention to use the image forming apparatus 2.

As described above, the direct restoration region 200C is arranged in the segment areas 1 and 12 that expand on both sides of the image forming apparatus 2. The disclosure is not limited to this setting. The direct restoration region 200C may be set up in one of the segment areas 1 through 12. The direct restoration region 200C may be set up in view of the environment where the image forming apparatus 2 is installed.

When the image forming apparatus 2 is installed at a place that is accessible from the right hand side or left hand side in an office, the direct restoration region 200C may be arranged in the segment areas 1 and 12 that are centered on the image forming apparatus 2 and expand on both sides of the image forming apparatus 2. Efficient restoration of the image forming apparatus 2 may be performed in view of the movement line of a person.

When the image forming apparatus 2 is installed at the corner of a room of an office, the direct restoration region 200C may be arranged in one of the segment areas 1 and 12 on both sides of the image forming apparatus 2.

When the segment area including the movement line along which the image forming apparatus 2 is more likely to be used is the segment area 6 or 7 in the environment where the image forming apparatus 2 is installed, the direct restoration region 200C is arranged in the segment area 6 or 7.

The exemplary embodiment of the disclosure has been described and the technical scope of the disclosure is not limited to the exemplary embodiment. In the exemplary embodiment, the image forming apparatus 2 is configurated to include the human sensor 100 but the human sensor 100 may be configurated to be external to the image forming apparatus 2. For example, the human sensor 100 may be installed in an area surrounding the image forming apparatus 2 or on the ceiling of a room. The human sensor 100 may be configurated to emit the signal within a range of 360 degrees. The image forming apparatus 2 may thus be efficiently restored whichever direction a person approaches from.

According to the exemplar embodiment, the apparatus that changes the power state in a stepwise fashion is the image forming apparatus 2. The disclosure is not limited to this setting. The apparatus supporting multiple power states may be applied to a variety of apparatuses including lighting equipment, air conditioning equipment, a signage or a robot. A variety of changes and equivalents of the configuration not departing from the scope of the technical spirit of the disclosure fall within the disclosure.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming system including a processor configured to: when a human sensor has detected a person within a first area falling within a first distance from the human sensor, control the human sensor such that human detection is performed within a second area falling within a second distance from the human sensor shorter than the first distance and restore an image forming apparatus from a first power state to a second power state that is higher in power state than the first power state; and when the human sensor has detected a person in the second area, restore the image forming apparatus to a third power state that is higher in power state than the second power state.
(((2)))

In the image forming system according to (((1))), the processor is configured to: when the human sensor has detected the person within the first area, control the human sensor such that the human detection is performed within a distance longer than the second distance within the second area in a specific direction connecting between a location where the person has been detected and the image forming apparatus; and when the controlled human sensor has detected a person, restore the image forming apparatus to the third power state.
(((3)))

In the image forming system according to (((2))), the processor is configured to: when the human sensor has detected the person within the first area, control the human sensor such that a distance for detection is longer as the human sensor approaches closer in angle to the specific direction within a predetermined sector including the specific direction; and when the controlled human sensor has detected a person, restore the image forming apparatus to the third power state.
(((4)))

In the image forming system according to one of (((1))) through (((3))), the processor is configured to: segment the first area into a plurality of sectoral segment areas centered on the image forming apparatus; when the human sensor has detected a person within any of the sectoral segment areas, control the human sensor such that the human detection is performed within a distance that is longer than the second distance within the second area within the sectoral segment area where the person has been detected; and when the controlled human sensor has detected a person, restore the image forming apparatus to the third power state.
(((5)))

In the image forming system according to (((4))), the processor is configured to: with respect to an adjacent sectoral segment area to the sectoral segment area where the person has been detected from among other sectoral segment areas than the sectoral segment area where the person has been detected, control the human sensor in the adjacent sectoral area such that the human detection is performed in the adjacent sectoral segment area within a distance longer than the second distance within the second area; and when the controlled human sensor has detected a person, restore the image forming apparatus to the third power state.
(((6)))

In the image forming system according to (((5))), the processor is configured to control the human sensor such that the human detection is performed in the adjacent sectoral segment area within a distance from the human sensor shorter than the sectoral segment area where the person has been detected.
(((7)))

In the image forming system according to one of (((1))) through (((6))), the processor is configured to, when the human sensor has detected a person within a predetermined area, restore the image forming apparatus from the first power state to the third power state.
(((8)))

In the image forming system according to (((7))), the predetermined area is arranged to be centered on the image forming apparatus and to be expanded toward both sides centered on the image forming apparatus.

What is claimed is:

1. An image forming system comprising:
a processor configured to:
when a human sensor has detected a person within a first area falling within a first distance from the human sensor, control the human sensor such that human detection is performed within a second area falling within a second distance from the human sensor shorter than the first distance and restore an image forming apparatus from a first power state to a second power state that is higher in power state than the first power state; and
when the human sensor has detected a person in the second area, restore the image forming apparatus to a third power state that is higher in power state than the second power state.

2. The image forming system according to claim 1, wherein the processor is configured to:
when the human sensor has detected the person within the first area, control the human sensor such that the human detection is performed within a distance longer than the second distance within the second area in a specific direction connecting between a location where the person has been detected and the image forming apparatus; and
when the controlled human sensor has detected a person, restore the image forming apparatus to the third power state.

3. The image forming system according to claim 2, wherein the processor is configured to:
when the human sensor has detected the person within the first area, control the human sensor such that a distance for detection is longer as the human sensor approaches closer in angle to the specific direction within a predetermined sector including the specific direction;
and when the controlled human sensor has detected a person, restore the image forming apparatus to the third power state.

4. The image forming system according to claim 1, wherein the processor is configured to:
segment the first area into a plurality of sectoral segment areas centered on the image forming apparatus;
when the human sensor has detected a person within any of the sectoral segment areas, control the human sensor such that the human detection is performed within a distance that is longer than the second distance within the second area within the sectoral segment area where the person has been detected; and
when the controlled human sensor has detected a person, restore the image forming apparatus to the third power state.

5. The image forming system according to claim 4, wherein the processor is configured to:
with respect to an adjacent sectoral segment area to the sectoral segment area where the person has been detected from among other sectoral segment areas than the sectoral segment area where the person has been detected, control the human sensor in the adjacent sectoral area such that the human detection is performed within a distance longer than the second distance within the second area; and
when the controlled human sensor has detected a person, restore the image forming apparatus to the third power state.

6. The image forming system according to claim 5, wherein the processor is configured to control the human sensor such that the human detection is performed in the adjacent sectoral segment area within a distance from the human sensor shorter than the sectoral segment area where the person has been detected.

7. The image forming system according to claim 1, wherein the processor is configured to, when the human sensor has detected a person within a predetermined area, restore the image forming apparatus from the first power state to the third power state.

8. The image forming system according to claim 7, wherein the predetermined area is arranged to be centered on the image forming apparatus and to be expanded toward both sides centered on the image forming apparatus.

9. An image forming system comprising:
means for, when a human sensor has detected a person within a first area falling within a first distance from the human sensor, controlling the human sensor such that human detection is performed within a second area falling within a second distance from the human sensor shorter than the first distance and restore an image forming apparatus from a first power state to a second power state that is higher in power state than the first power state; and
means for, when the human sensor has detected a person in the second area, restoring the image forming apparatus to a third power state that is higher in power state than the second power state.
